(19) United States
(12) Patent Application Publication
(10) Pub. No.: US 2023/0186240 A1
(43) Pub. Date: Jun. 15, 2023

(54) Systems, Methods and Architectures for Dynamic Re-Evaluation of Rights Management Rules for Policy Enforcement on Downloaded Content

(71) Applicant: Open Text SA ULC, Halifax (CA)

(72) Inventor: Uwe Geisert, Munich (DE)

(21) Appl. No.: 18/158,239

(22) Filed: Jan. 23, 2023

Related U.S. Application Data
(63) Continuation of application No. 14/614,731, filed on Feb. 5, 2015.
(60) Provisional application No. 61/936,711, filed on Feb. 6, 2014.

(51) Int. Cl. G06Q 10/10; G06Q 50/18; H04L 9/40

(52) U.S. Cl. CPC G06Q 10/10; G06Q 50/184; H04L 63/0442; G06Q 2220/18; H04L 2463/101

(57) ABSTRACT

A control logic component at the server side may, responsive to a request to access protected content residing on a client machine, dynamically evaluate one or more rules. The request may be received from a client application running on the client machine by a rights management services server or by an agent running on the client machine. In some embodiments, the control logic component can be hosted in a cloud computing environment, on an enterprise server, or provided as a service. Each rule may reference a policy such as a digital rights management policy. The control logic component may determine, based on condition(s) set forth in the rule, if any policy is current and applicable to the protected content and communicate its findings to the requesting server or agent such that they can take appropriate action to protect the downloaded content.

### CROSS-REFERENCE TO RELATED APPLICATION(S)

This application is a continuation of, and claims a benefit of priority under 35 U.S.C. § 120 from U.S. patent application Ser. No. 14/614,731, filed Feb. 5, 2015, entitled “SYSTEMS, METHODS AND ARCHITECTURES FOR DYNAMIC RE-EVALUATION OF RIGHTS MANAGEMENT RULES FOR POLICY ENFORCEMENT ON DOWNLOADED CONTENT,” which is a conversion of, and claims a benefit of priority under 35 U.S.C. § 119 from U.S. Provisional Patent Application No. 61/936,711, filed Feb. 6, 2014, entitled “SYSTEMS, METHODS AND ARCHITECTURES FOR DYNAMIC RE-EVALUATION OF RIGHTS MANAGEMENT RULES FOR POLICY ENFORCEMENT ON DOWNLOADED CONTENT,” which are hereby incorporated herein for all purposes.

### TECHNICAL FIELD

This disclosure relates generally to rights management. More particularly, embodiments disclosed herein relate to dynamic re-evaluation of rights management rules for policy enforcement on downloaded content.

### BACKGROUND OF RELATED ART

The term “digital rights management (DRM)” generally refers to technologies used by companies such as content providers and individuals to protect and safeguard their digital assets from unauthorized access, use, and distribution (online or offline). DRM technologies may include special software systems for controlling access, viewing, writing, copying, printing, forwarding, and etc. with respect to digital assets. Examples of digital assets may include copyrighted materials, confidential documents, etc.

DRM is important in today's digital world. However, the actual DRM technologies can be very complex and difficult to implement. As a result, although a great need exists in the art, only a select few DRM systems currently exist on the market. One example is a component of Microsoft® Windows server software known as the Rights Management Services (RMS). RMS requires Microsoft Active Directory services (and hence is also referred to as “AD RMS”), Microsoft Internet Information Services (IIS), and Microsoft SQL Server. AD RMS servers are implemented as a set of Web service components that run on IIS and work in connection with Microsoft SQL Server and Active Directory Domain Services. Currently, applications supporting DRM using Microsoft's RMS servers are generally developed by Microsoft and are highly integrated with Microsoft's DRM technologies. An example of this integration is illustrated in FIG. 1.

FIG. 1 depicts a diagrammatic representation of the infrastructure and operation of an example RMS system 100. In the example of FIG. 1, RMS server 150 is coupled to database server 160 storing SQL database 162 and to AD server 170 storing active directory 172.

In operation, user 101 may wish to protect a document that they had created. User 101 may send user data 111 (e.g., credentials) to RMS server 150 via an RMS client running on a computing device associated with user 101. RMS client may be an application that is part of an Office suite developed by Microsoft (e.g., Word, PowerPoint, Publisher, etc.). Such an application may be referred to as an RMS client-enabled application.

In response, RMS server 150 may check with AD server 170 to authenticate user 101 and establish permissions. Suppose user 101 is authenticated, RMS server 150 may issue and return client licensor certificate 115 to user 101. RMS server 150 may communicate with database server 160 to record the issuance of client licensor certificate 115 in SQL database 162.

User 101 defines policies for their document using the RMS client-enabled application running on their computing device and the RMS client uses client licensor certificate 115 to encrypt the document to produce encrypted document 155 and create and sign a publishing license containing the user-defined policies. The RMS client then attaches a copy of the publishing license, along with the user-defined policies, to encrypted document 155 prior to publishing or distributing encrypted document 155. At this point, the user-defined policies are attached to and travel with encrypted document 155.

In the example of FIG. 1, user 101 may send document 155 (which is encrypted and which has a copy of the signed publishing license containing the user-defined policies attached thereto) to user 102. Before user 102 can open document 155, user 102 must supply user data 122 and the publishing license from document 155 to RMS server 150 for verification. User data 122 may include the necessary credentials such as a password associated with user 102. This process is done via an RMS client-enabled application running on a computing device associated with user 102. Specifically, when user 102 selects document 155 for opening, the RMS client-enabled application running on the computing device associated with user 102 calls RMS server 150 to request and acquire an end-user license. RMS server 150 determines, based on user data 122 and the publishing license from document 155 and checking with AD server 170, if user 102 should have access to document 155 (which is authored by user 101 in the example of FIG. 1). If user 102 has no right at all to access document 155, RMS server 150 does not issue an end-user license. If user 102 is permitted to access document 155 (e.g., per a permission by user 101 as established with AD server 170), RMS server validates user 102 based on user data 122 and issues end-user license 125. End-user license 125 enables the RMS client-enabled application running on the computing device associated with user 102 to decrypt and access document 155 in accordance with terms and conditions set forth in end-user license 125.

The RMS client ensures that user 102 conforms to any user-defined (by user 101) policies attached to document 155 and honors the terms and conditions indicated in end-use license 125, which might restrict certain actions. This ensures that document 155 is protected as intended by user 101 and is only consumed by user 102 in accordance with the policies specified by user 101.

As the above example illustrates, in an RMS system, content is protected according to the usage rights and conditions that a user as an author or a publisher chooses to allow for the content. This protection is fixed and remains with the protected content, no matter where it goes.

This type of fixed digital rights protection can be an issue in an enterprise computing environment. In an enterprise computing environment, administrators may create, develop, audit, revoke and manage usage policies, such as a read-only policy. When a document is downloaded from an enterprise server such as a content server and the appropriate usage policy for this document has been applied, the protection is fixed. In some cases, the usage policy or other policies applicable to the document may change at the backend (for example, on the content server side). However, such policy changes typically are not promulgated to the frontend and thus may have no effect on the document that had already been downloaded and stored on a client device.

One way to address this issue is to provide a document control mechanism between the content server at the backend (i.e., at the server side) and the RMS client-enabled application at the frontend (i.e., at the client side). FIG. 2 depicts a diagrammatic representation of an infrastructure and operation of enterprise RMS system 200 with content server 280, enterprise content repository 290, RMS server 285, centrally managed enterprise content usage policies 288, and policy enforcement agent 245.

In the example of FIG. 2, content server 280 is configured for managing enterprise content in an enterprise computing environment. User 201 may be a content creator or knowledge worker for the enterprise and may create and upload unprotected document 211 to content server 280. Content server 280 may encrypt the uploaded document to thereby produce encrypted document 255, store encrypted document 255 in enterprise content repository 290, and manage encrypted document 255 stored in enterprise content repository 290 according to enterprise content usage policies 288. Enterprise content usage policies 288 may be created and managed by administrators of enterprise RMS system 200 (e.g., using a policy editor provided by RMS server 285).

Suppose user 202 is allowed to access content server 280 and download encrypted document 255 from enterprise content repository 290 using a client application running on a computing device associated with user 202. Policy enforcement agent 245 may be configured to monitor application events and call RMS server 285 when user 202 selects encrypted document 255 for opening. RMS server 285 may evaluate enterprise content usage policies 288 and provide instructions to policy enforcement agent 245. Policy enforcement agent 245, in turn, ensures that enterprise content usage policies 288 are appropriately applied to the document at issue. For example, encrypted document 255 may have a policy that allows for full access when encrypted document 255 was first downloaded by user 202. However, it has since been replaced with a read-only policy. This information is communicated to policy enforcement agent 245 at the time when user 202 selects to open encrypted document 255. In accordance with the new read-only policy, policy enforcement agent 245 will operate to decrypt document 255 and allow document 255 to be opened on the computing device associated with user 202 as a read-only document.

### SUMMARY

Prior RMS approaches, including those described above, are not without drawbacks. For instance, RMS rules which govern application of RMS policies may change. However, they are not dynamically re-evaluated for policy enforcement whenever protected content is accessed on a client device. Thus, there remains a gap in policy enforcement on protected content that has been downloaded and stored on a client device. This disclosure is directed to systems, methods and computer program products for dynamic re-evaluation of rights management rules for policy enforcement on downloaded content.

In this disclosure, the term “dynamic” is used to refer to the ability, embodied in a special control logic component, for instance, to take appropriate action at the time when the action is needed. For example, rights management rules pertaining to a document may be evaluated when the document was first persisted at the backend (e.g., on a non-transitory data storage device operating in a network computing environment at the server side). After the document is downloaded to a client device, these rights management rules, which may or may not have changed since the document was first persisted, may be dynamically re-evaluated at the time when an attempt is made to access the document now residing on the client device. In this case, “dynamic” refers to the ability of a special control logic component (e.g., a particularly programmed server, engine, plug-in, agent, module, or the like) to take appropriate action (e.g., re-evaluation) at the time when the action is needed (e.g., whenever an attempt is made to access the downloaded document residing on the client device).

In some embodiments, a method may include receiving, by a server, a request for a use license from a client device communicatively connected to the server over a network connection. The request may contain a public key of the client device and an encrypted publishing license associated with a piece of content existing on the client device. The piece of content may have been downloaded from a repository owned and operated by an entity.

The method may further include the server decrypting the publishing license to produce a content identifier associated with the piece of content. The server may perform the decrypting using a private key of the server. The method may include performing dynamic rules re-evaluation. Specifically, a special control logic component may dynamically evaluate one or more rules to determine what/which current policy is applicable to the piece of content. In this disclosure, each rule may have a name, a description, and a condition and may reference a policy. In some embodiments, the rules may be evaluated in a predetermined order.

The method may further include generating and encrypting a use license using the public key of the client device. The use license may contain a content key and at least one current policy applicable to the piece of content. The encrypted use license may be returned to the client device and a client module residing on the client device may decrypt the use license using a private key of the client device to obtain the content key and the at least one current policy and also decrypt the piece of content existing on the client device using the content key. The at least one current policy may specify one or more permissions relative to the piece of content. The client module may then enforce the one or more permissions in accordance with the at least one current policy.

In some embodiments, control logic for dynamic rules re-evaluation can be implemented in various ways at the server side. In some embodiments, a special control logic component can be hosted in a cloud computing environment, on an enterprise server, or provided to an RMS server (e.g., RMS server 150 of FIG. 1) or a client agent (e.g., policy enforcement agent 245 of FIG. 2) as a service. Responsive to a request to access protected content residing on a client machine, the special control logic component may dynamically evaluate one or more rules. The request may be received from a client application running on the client machine by the RMS server or the client agent and communicated to the rules engine. A rule may reference a policy such as a digital rights management policy. The special control logic component may determine, based on condition(s) set forth in the rule, if the policy still applicable to the protected content and/or how it should be applied and communicate its findings to the requesting RMS server or client agent such that they can take the necessary and appropriate action to protect the downloaded content now residing on the client machine.

One embodiment may comprise a system having a processor and a memory and configured to implement the method. One embodiment may comprise a computer program product that comprises a non-transitory computer-readable storage medium which stores computer instructions that are executable by a processor to perform the method.

Numerous other embodiments are also possible.

Embodiments can provide many advantages. For example, by evaluating and dynamically re-evaluating rules at the server side, embodiments can ensure that any rules governing application of policies remain current and up-to-date, providing a finer, more dynamic and granular control in policy enforcement on downloaded content, addressing a gap in existing RMS approaches, and fulfilling a great need in the DRM art.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts a diagrammatic representation of the infrastructure and operation of a prior RMS system;

FIG. 2 depicts a diagrammatic representation of the infrastructure and operation of a prior enterprise RMS system;

FIG. 3 depicts a diagrammatic representation of a dynamic RMS (DRMS) component integrated with an RMS system according to one embodiment;

FIG. 3A depicts a diagrammatic representation of a DRMS component hosted on a server communicatively connected to an RMS system according to one embodiment;

FIG. 3B depicts a diagrammatic representation of a DRMS service hosted in a cloud computing environment and provided to an RMS system according to one embodiment;

FIG. 4 depicts a diagrammatic representation of a DRMS component integrated with an enterprise RMS system according to one embodiment;

FIG. 4A depicts a diagrammatic representation of a DRMS component hosted on a server communicatively connected to an enterprise RMS system according to one embodiment;

FIG. 4B depicts a diagrammatic representation of a DRMS service hosted in a cloud computing environment and provided to an enterprise RMS system according to one embodiment;

FIG. 5 depicts a diagrammatic representation of an implementation of a DRMS system according to one embodiment;

FIG. 5A depicts a diagrammatic representation of an implementation of a DRMS system hosted in a cloud computing environment according to one embodiment;

FIG. 6 depicts a diagrammatic representation of an example infrastructure including a document management system and a DRMS system according to some embodiments;

FIG. 7 is a flow chart illustrating an example of operation of a DRMS system according to some embodiments;

FIG. 8 is a flow chart illustrating an example of operation of a DRMS system according to some embodiments;

FIG. 9 depicts a diagrammatic representation of a screenshot showing example rules according to one embodiment;

FIG. 10A depicts a diagrammatic representation of a screenshot showing an example rule referencing a policy according to one embodiment;

FIG. 10B depicts a diagrammatic representation of a screenshot showing example conditions contained in the example rule of FIG. 10A according to one embodiment; and

FIG. 11 depicts a diagrammatic representation of a screenshot showing an example policy according to one embodiment.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

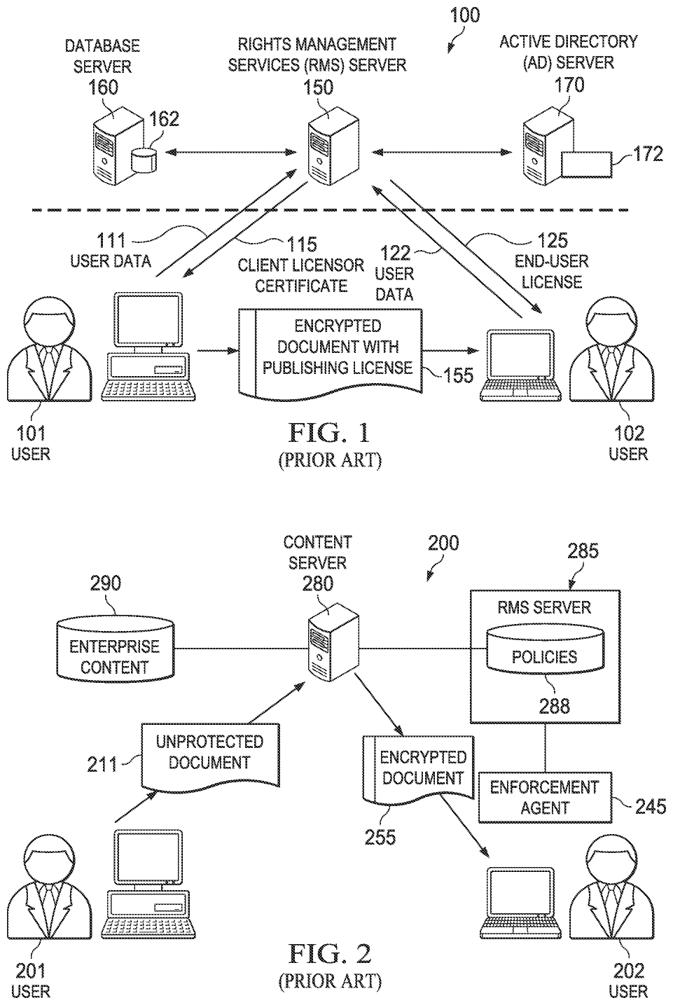

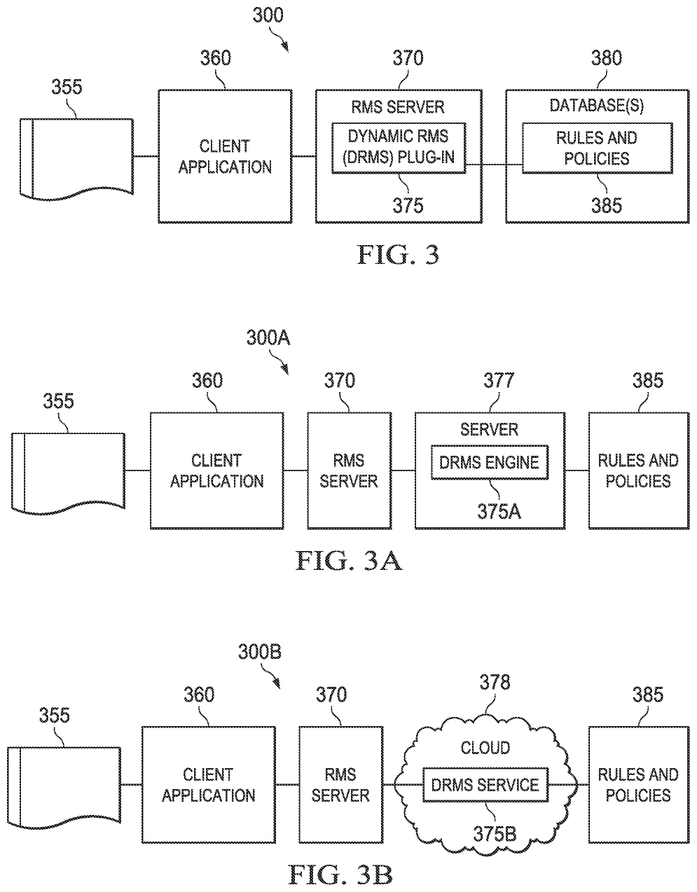

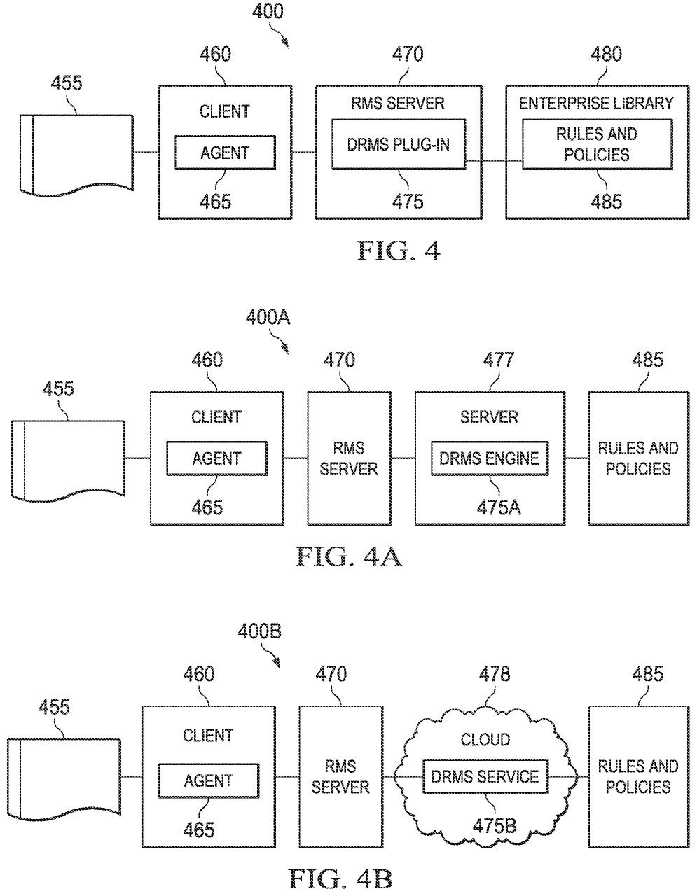

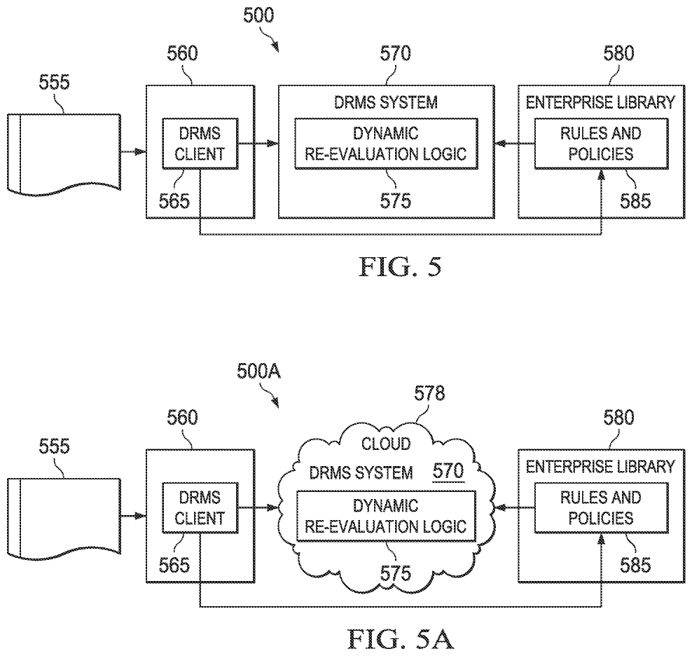

As discussed above, prior RMS approaches, including those described above with reference to FIG. 1 and FIG. 2, are not without drawbacks. This disclosure provides several approaches to remedy these drawbacks and provide improvements needed in the DRM art. While these approaches all provide dynamic re-evaluation of rights management rules, they can be implemented in various ways. As examples, FIGS. 3-4B show integration approaches and FIGS. 5-5A show infrastructural approaches.

FIG. 3 depicts a diagrammatic representation of a dynamic RMS (DRMS) component with dynamic rules re-evaluation logic integrated with an RMS system according to one embodiment. Specifically, in this example, system 300 may include DRMS component 375 which is integrated into rights management services operating on RMS server 370. In one embodiment, DRMS component 375 may be implemented as a DRMS plug-in.

As shown in FIG. 3, system 300 may further include database(s) 380. Database(s) 380 may run on one or more server machines and be responsible for providing configurable RMS rules and policies 385. Policies stored in database(s) 380 do not allow caching of end-user licenses. This forces client application 360 to contact RMS server 370 on each document access.

When document 355 is accessed, RMS server 370 notifies or calls DRMS plug-in 375. In turn, DRMS plug-in 375 contacts database(s) 380, dynamically re-evaluates RMS rules and policies 385, determines a current policy (or policies) applicable to document 355, retrieves the policy or policies thus determined from database(s) 380, and provides the retrieved policy or policies to RMS server 370. RMS server 370 then applies the current policy or policies provided by DRMS plug-in 375 to document 355. This approach may be applied to address the drawbacks of a conventional RMS system discussed above with reference to FIG. 1.

Those skilled in the art will appreciate that there can be various types and/or levels of integration with RMS server 370. For example, FIG. 3A depicts a diagrammatic representation of system 300A having DRMS engine 375A implementing dynamic rules re-evaluation logic disclosed herein. In this example, DRMS engine 375A is hosted on server 377 communicatively connected to RMS server 370. DRMS engine 375A has access to RMS rules and policies 385 which may be stored in database(s) 380 as described above, stored on server 377, or maintained elsewhere such as a rules database server and/or a policy database server.

As another example, FIG. 3B depicts a diagrammatic representation of system 300B having DRMS service 375B implementing dynamic rules re-evaluation logic disclosed herein. In this example, DRMS service 375B is hosted in a cloud computing environment (e.g., cloud 378) and provides dynamic rules re-evaluation logic as a service to RMS server 370. DRMS service 375B has access to RMS rules and policies 385 which may be stored in database(s) 380 as described above, hosted in cloud 378, or maintained elsewhere such as a rules database server and/or a policy database server.

FIG. 4 depicts a diagrammatic representation of a DRMS component integrated with an enterprise RMS system according to one embodiment. Specifically, in this example, system 400 may include DRMS component 475 which is integrated into rights management services operating on enterprise RMS server 470. In one embodiment, DRMS component 475 may be implemented as a DRMS plug-in.

As shown in FIG. 4, system 400 may further include enterprise library 480. Enterprise library 480 may run on one or more server machines and be responsible for providing configurable RMS rules and policies 485. When client application 460 attempts to access document 455, RMS agent 465 running on a client device may check with enterprise RMS server 470 in a manner similar to policy enforcement agent 245 described above with reference to FIG. 2. Enterprise RMS server 470 may utilize DRMS plug-in 475 to contact enterprise library 480, dynamically re-evaluate RMS rules and policies 485, determine a current policy (or policies) applicable to document 455, and retrieve the policy or policies thus determined from enterprise library 480, even if enterprise RMS server 470 may maintain its own RMS policies. Enterprise RMS server 470 may then apply the current policy or policies to document 455. This approach may be applied to address the drawbacks of a conventional enterprise RMS system discussed above with reference to FIG. 2.

Those skilled in the art will appreciate that there can be various types and/or levels of integration with enterprise RMS server 470. For example, FIG. 4A depicts a diagrammatic representation of system 400A having DRMS engine 475A implementing dynamic rules re-evaluation logic disclosed herein. In this example, DRMS engine 475A is hosted on server 477 communicatively connected to enterprise RMS server 470. DRMS engine 475A has access to RMS rules and policies 485 which may be stored in enterprise library 480 as described above, stored on server 477, or maintained elsewhere such as a rules database server and/or a policy database server.

As another example, FIG. 4B depicts a diagrammatic representation of system 400B having DRMS service 475B implementing dynamic rules re-evaluation logic disclosed herein. In this example, DRMS service 475B is hosted in a cloud computing environment (e.g., cloud 478) and provides dynamic rules re-evaluation as a service to enterprise RMS server 470. DRMS service 475B has access to RMS rules and policies 485 which may be stored in enterprise library 480 as described above, hosted in cloud 478, or maintained elsewhere such as a rules database server and/or a policy database server.

The example integration approaches described above with reference to FIGS. 3, 3A, 3B and FIGS. 4, 4A, and 4B leverage rights management services operating in existing RMS systems such as the MS RMS Server or other similar products. Those skilled in the art will appreciate that all such integrated systems that are configured for dynamic re-evaluation of rights management rules on downloaded content according to embodiments disclosed herein are within the scope of this disclosure, although the technology of integration may vary from implementation to implementation.

In addition to integration approaches described above, infrastructural approaches may be taken to dynamic re-evaluate rights management rules governing policies applicable to downloaded content, examples of which are shown in FIGS. 5 and 5A.

FIG. 5 depicts a diagrammatic representation of an implementation of a DRMS system according to one embodiment. Specifically, in this example, system 500 may include DRMS client 565 communicatively connected to DRMS system 570 and enterprise library 580. Enterprise library 580 may run on one or more server machines and be responsible for providing configurable RMS rules and policies 585.

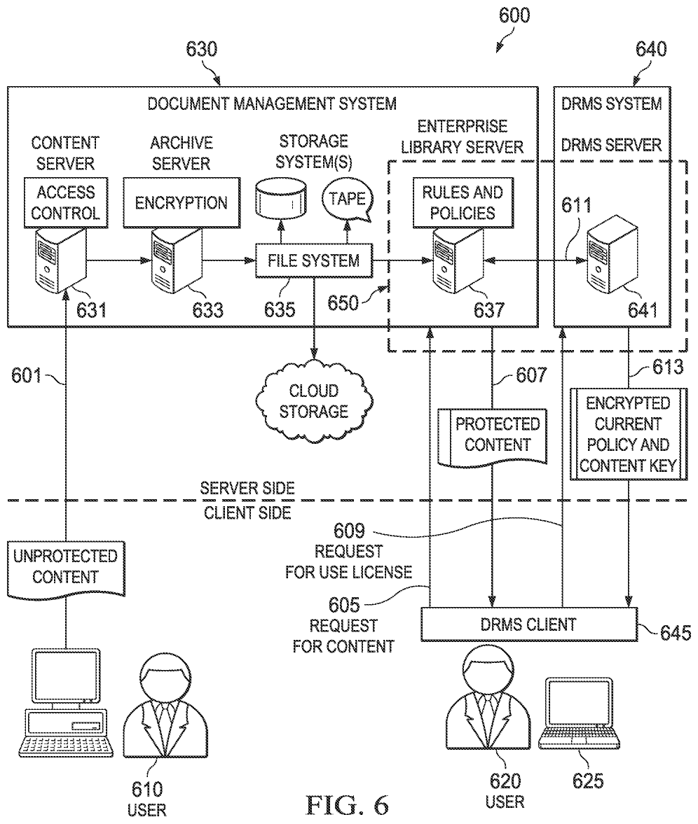

As an example, DRMS client 565 may retrieve document 555 from a document management system associated with enterprise library 580. At retrieval time, document 555 may be protected according to configurable RMS rules and policies 585. When client application 560 attempts to open document 555, DRMS client 565 checks with DRMS server 570 which, in turn, calls enterprise library 580 and, via dynamic re-evaluation logic 575, dynamically re-evaluate configurable RMS rules and policies 585 and apply the most current, applicable RMS rules and policies 585 to document 555. An example infrastructure where this process can take place is described in detail below with reference to FIG. 6.

Those skilled in the art will appreciate that dynamic re-evaluation logic 575 can be implemented in various ways. For example, FIG. 5A depicts a diagrammatic representation of system 500A having DRMS server 570 with dynamic re-evaluation logic 575 hosted in a cloud computing environment (e.g., cloud 578). RMS rules and policies 585 or even entire enterprise library 580 may be hosted in cloud 578 or maintained elsewhere such as a rules database server and/or a policy database server communicatively connected to DRMS server 570. Other implementations may also be possible.

Referring to FIG. 6, a diagrammatic representation of an example infrastructure and operation of a DRMS system according to one embodiment is depicted. Specifically, in infrastructure 600, user 610 may upload (step 601) unprotected content such as a document to content server 631. In one embodiment, user 610 may be an employee of an entity owning and operating content server 631 and may be tasked to create the content. During creation, the document may be unprotected. In one embodiment, user 610 can be anyone who has access to content server 631. Content server 631 may be part of document management system 630 which includes archive server 633, file system 635, and enterprise library server 637. Document management system 630 may be implemented on one or more server machines.

After the document is uploaded to document management system 630, content server 631 may operate to restrict access to the document and forward the document for archival. Archive server 633 may operate to encrypt the document and store the encrypted document in file system 635 at one or more storage locations (e.g., on a disk based storage system, in a tape based storage system, in a cloud based storage system, etc.). Here, the encryption by archive server 633 on the document is independent of the RMS protection and encryption. This archive server encryption guarantees that the content is securely stored on the storage—no one having direct access to the storage can read the content. The rules for the archive server encryption are generally maintained in the archive server administration and can be independent of the RMS protection rules. The archive server encryption shown in FIG. 6 is part of document management system 630 and illustrates that documents in a document management system can be secure on all levels in an infrastructure like infrastructure 600. As those skilled in the art can appreciate, embodiments of infrastructure 600 can be built with the respective components from Open Text. FIG. 6 therefore provides an example infrastructure where the invention disclosed herein may be implemented and may add benefits to document management system 630.

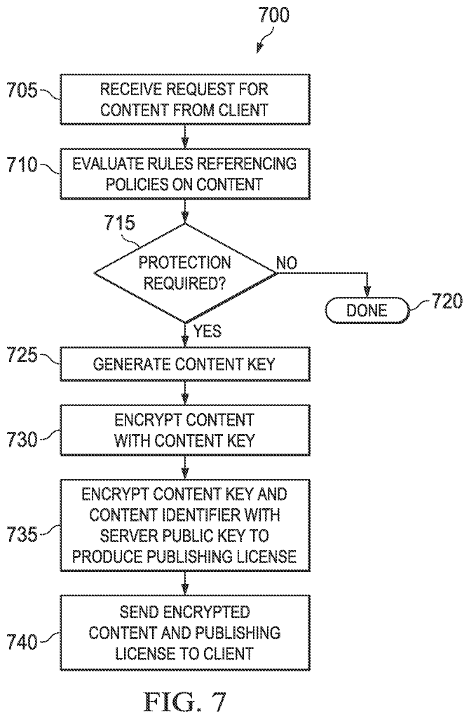

User 620 may send request 605 to document management system 630 for downloading a document. Request 605 may be sent by DRMS client 645 running on client device 625 associated with user 620. Note that the document is encrypted on the storage, but as soon as it leaves archive server 633, it may no longer be encrypted. Enterprise library server 637 may evaluate configurable policies and rules to determine whether and/or what RMS protection is needed and, if so, protect the document according to the configurable policies and rules. A detailed example of this process is provided below with reference to FIG. 7. Document management system 630 may then send response 607 containing the RMS protected document to client device 625.

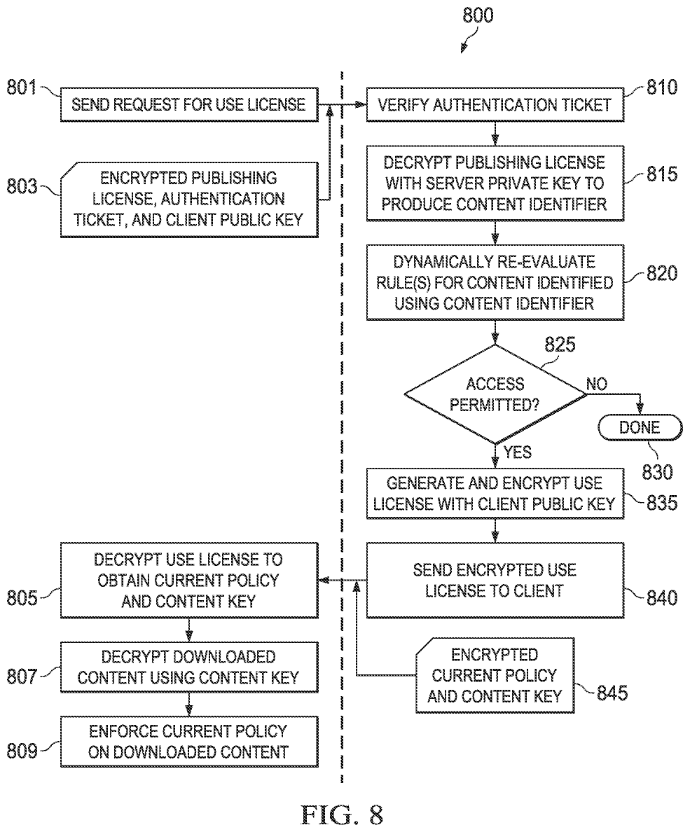

When user 620 attempts to open the RMS protected document downloaded from document management system 630, DRMS client 645 may operate to send request 609 to DRMS system 640 for a use license. DRMS server 641 implementing DRMS system 640 may operate (via a special control logic component configured for dynamic rules re-evaluation) to check with enterprise library server 637 (step 611). The special control logic may also be implemented at enterprise library server 637 or may cause enterprise library server 637 to dynamically re-evaluate configurable rules to determine one or more current policies applicable to the downloaded content. Response 613, which contains an encrypted current policy, is then sent to client device 625. A detailed example of this process is provided below with reference to FIG. 8.

One of ordinary skill in the art appreciates that, although document management system 630 and DRMS system 640 are shown as two separate systems in FIG. 6, they may be implemented as a single system. Additionally, although enterprise library server 637 and DRMS server 641 are shown as two separate server machines in FIG. 6, they may be implemented on one server machine such as server 650. Other implementations are also possible.

Turning now to FIG. 7, which is a flow chart illustrating an example of operation of a DRMS system according to one embodiment. In this example, process 700 may begin when a server receives a request for content from a client (step 705). The server may be a content server such as content server 631 of FIG. 6 or an enterprise library server such as enterprise library server 637 of FIG. 6. The server evaluates configurable RMS rules which reference policies on the requested content (step 710). If the server determines that RMS protection for the requested content is not required (step 715), process 700 ends (step 720). Otherwise, the server generates a content key (step 725), encrypts the requested content with the content key (step 730), and encrypts the content key and a content identifier using the server's public key (step 735). This produces a publishing license. The publishing license is sent with the encrypted content to the client requesting it (step 740).

Since the downloaded content is RMS protected, when an attempt is made to access the downloaded document (e.g., when an application running on the client device attempts to open it), this triggers a dynamic re-evaluation of rights management rules at the backend. This is illustrated in FIG. 8.

In this example, process 800 may begin when a client sends a request for a user license to a server (step 801). The server may be any appropriate server at the server side, for instance, an enterprise library server such as enterprise library server 637 of FIG. 6 or a DRMS server such as DRMS server 641 of FIG. 6. Request 803 may contain an encrypted publishing license, an authentication ticket, and a public key of the client. The server (or any appropriate server at the server side) may operate to verify the authentication ticket (step 810) and decrypt the publishing license received from the client using a private key of the server (step 815). This produces a content identifier for the content with which the publishing license is associated. Using the content identifier, the server can dynamically re-evaluate any RMS rule(s) to determine one or more current policies applicable to the content associated with the content identifier (step 820).

Those skilled in the art will appreciate that step 820 may be performed by the server at which the request is received (e.g., dynamic re-evaluation logic 575 embodied on DRMS system 570 of FIG. 5 or hosted in cloud 578 of FIG. 5A), or by any appropriate server or service at the server side implementing a special control logic component disclosed herein, including, but not limited to, DRMS component 375 integrated with RMS server 370 of FIG. 3, DRMS engine 375A hosted on server 377 of FIG. 3A, DRMS service 375B hosted in cloud 378, DRMS component 475 integrated with enterprise RMS server 470 of FIG. 4, DRMS engine 475A hosted on server 477 of FIG. 4A, or DRMS service 475B hosted in cloud 478.

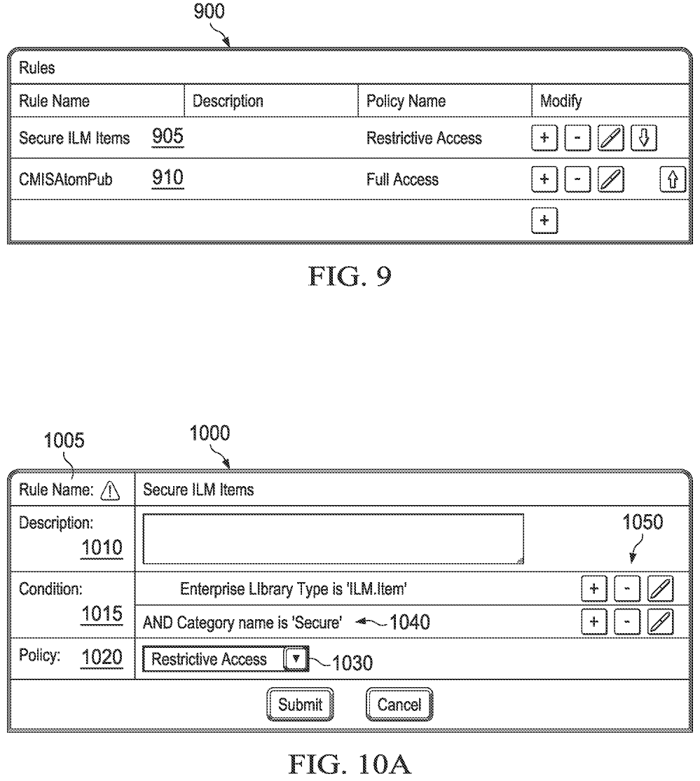

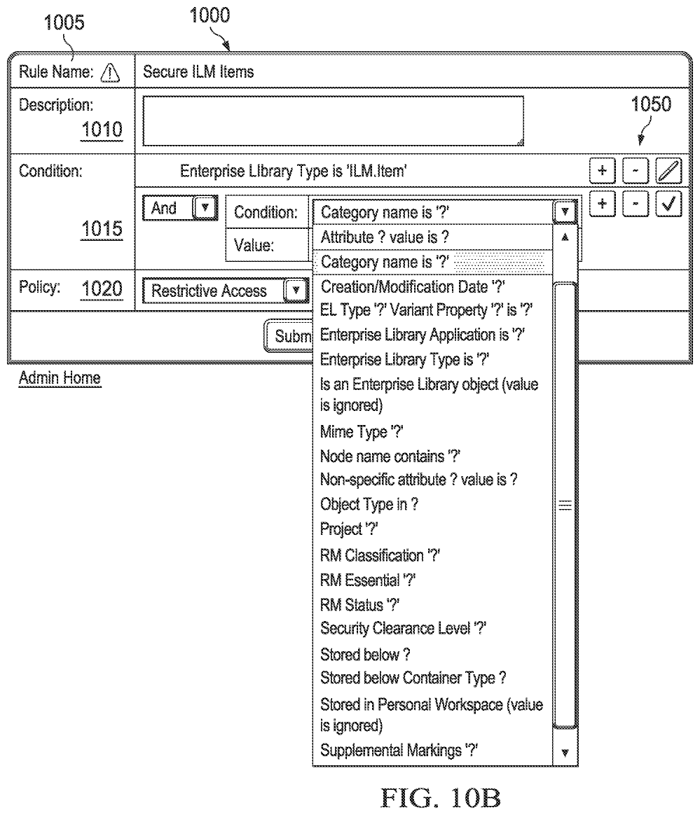

In some embodiments, step 820 may further comprise determining RMS rule(s) applicable to the content associated with the content identifier, accessing a rules database, an enterprise library, or any appropriate data structure persistently storing a set of RMS rules, and retrieving from there one or more RMS rules applicable to the content associated with the content identifier. In some embodiments, the determination as to what RMS rule may apply may depend on the requested content's content type, classification, categorization, or the like. For example, documents that have been classified as confidential may have a particular rule governing how a specific policy on confidential documents should be applied. To this end, FIG. 9 shows by example different rules, each referencing a particular policy; FIG. 10A shows by example configurable conditions that may trigger application of a particular policy; and FIG. 10B shows by example how such conditions may be modified within a rule, without having to change or modify a referenced policy. FIGS. 9-10B are explained in detail below.

Referring to FIG. 8, it is possible that condition(s) set forth in a rule applicable to the content may have been modified or changed subsequent to the content being downloaded to a client device. That is, even if a policy referenced in the rule (and applicable to the content) has not changed, the condition(s) of the rule may have been modified after the content is downloaded. However, traditionally, the server at which the request to access the downloaded content is received does not re-evaluate the rule again at access time and, therefore, may have no knowledge that the rule has changed. This additional step (step 820) provides the server with a new ability to re-evaluate applicable rule(s) at each access and thereby ensure that the policy can be accurately applied to downloaded content according to the most up-to-date rule(s).

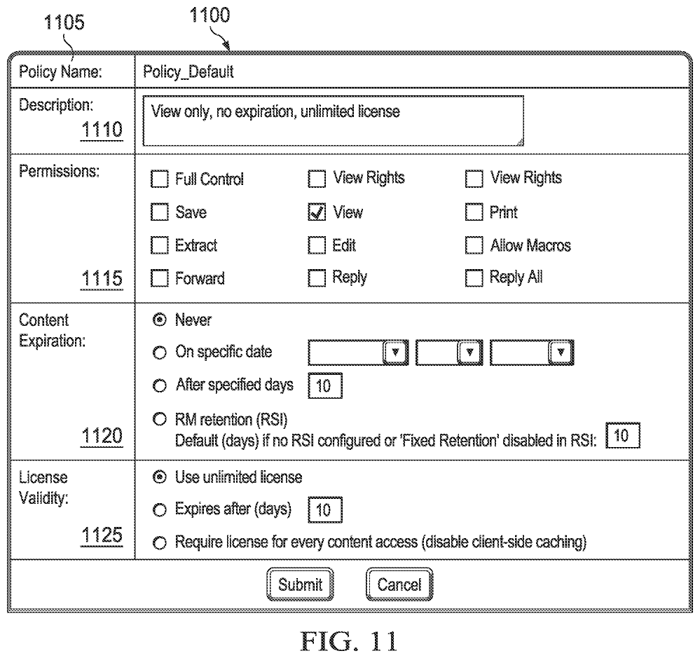

Accordingly, in some embodiments, step 820 may further comprise analyzing the one or more RMS rules applicable to the content associated with the content identifier. As a specific example, suppose a rule has a first condition specifying a content type and a second condition specifying a category name. If both conditions are met, then a policy referenced in the rule applies to the content (see, e.g., FIG. 10A). This policy may be the same policy applied to the content when the content was downloaded or it may be a modified or different policy. As illustrated in FIG. 11 and explained below, a policy may specify various types of permissions such as full control, view only, etc. which define the scope of use of the content.

In some embodiments, step 820 may further comprise providing a result of the analysis. In some embodiments, the result may include a link or reference to a current policy. The server may access the policy and determine what access permission(s), if any, the user has on the downloaded content (step 825). If, according to a current policy, the user is not permitted to access to the downloaded content at all, process 800 ends (step 830). If the user is permitted to access the downloaded content, the server then operates to generate a use license and encrypt the use license with the client's public key (step 835). The server may then communicate the encrypted use license to the client (step 840). User license 845, in this case, may contain an encrypted current policy (which, as illustrated in FIG. 11, may specify the appropriate access permission(s)) and an encrypted content key.

The client may decrypt the use license using the client's private key (step 805). This produces the current policy and the content key. The client may decrypt the downloaded content using the content key (step 807) and operate to enforce the current policy on the downloaded content (step 809). This is further explained below.

FIG. 9 depicts a diagrammatic representation of a screenshot showing example rules according to one embodiment. In this example, rules 900 may be maintained in an enterprise library owned and operated by an entity and may apply to content owned by the entity and stored across storage systems. As shown in FIG. 9, example rules 900 comprise a set of rules (e.g., rule 905 and rule 910), each of which references or otherwise is associated with a policy. In some embodiments, rules 900 may be defined based on document properties. Examples of document properties may include, but are not limited to, records management (RM) classifications, storage location of a document at issue, metadata properties, RM attributes, etc. Further, there can be various types of policies (e.g., a restrictive access policy, a full access policy, etc.). On each access, the enterprise library is contacted to re-evaluate rules 900 and retrieve the respective policy in its current state.

FIG. 10A depicts a diagrammatic representation of a screenshot showing an example rule referencing a policy according to one embodiment. Specifically, example rule 1000 may contain a plurality of fields including rule name 1005, description 1010, condition 1015, and policy 1020. Notice that rule 1000 does not contain the actual policy referenced in field 1020. Rather, rule 1000 provides a link (via field 1020) to policy 1030 and specify condition(s) 1040 for when police 1030 is to be applied.

The association (via field 1020) and relationship (via condition(s) 1040) between rule 1000 and policy 1030 can be readily modified via edit functions 1050 (e.g., add, delete, edit, etc.). FIG. 10B depicts a diagrammatic representation of a screenshot showing a change to a condition specified by rule 1000. Suppose the change modifies the security category for a particular type of content. In this case, the policy itself may not have changed. What has changed may relate to how/whether/what policy 1030 may be applied to downloaded content. Re-evaluation of rule 1000 at access time can ensure that this change is promulgated to all affected content, including downloaded content. Specifically, as discussed above, whenever an attempt is made to access downloaded content, a special control logic component implemented at the server side may dynamically re-evaluate rule 1000 and determine whether rule 1000 applies (based at least on condition(s) set forth therein related to the requested content) and, if so, what policy 1030 referenced in field 1020 may apply. In this way, even if a rule applicable to a document is changed after the document is downloaded to a client device, the special control logic component can re-evaluate the rule at access time, allowing the correct, most up-to-date policy to be accurately applied to the downloaded document.

Independently, policies themselves may be defined, configured and/or modified. FIG. 11 depicts a diagrammatic representation of a screenshot showing an example policy according to one embodiment. In this example, policy 1100 comprises policy name 1105, description 1110, permissions 1115, content expiration 1120, and license validity 1125. Permissions 1115 define the scope of use of the content. Content expiration 1120 defines the lifespan of the content. License validity 1125 defines the type of use of the content. These can be enforced on the downloaded content in a manner known to those skilled in the art and thus are not further described herein.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. In general, the functions of the invention can be achieved by any various means known to those skilled in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

What is claimed is:

1. A method, comprising:
a server module embodied on non-transitory computer memory receiving a request for a use license from a client device communicatively connected to the server module over a network connection, the request containing a public key of the client device and an encrypted publishing license associated with a piece of content existing on the client device;
the server module decrypting the publishing license to produce a content identifier associated with the piece of content, the server module performing the decrypting using a private key of the server module;
a control logic component dynamically re-evaluating one or more rules associated with the piece of content to determine which policy is current and applicable to the piece of content, each of the one or more rules referencing a policy;
the server module generating and encrypting a use license using the public key of the client device, the use license containing a content key and a current policy for the piece of content; and
the server module sending the encrypted use license to the client device over the network connection, wherein a client module residing on the client device decrypts the use license using a private key of the client device to obtain the content key and the current policy, decrypts the piece of content existing on the client device using the content key, and enforces one or more permissions specified in the current policy relative to the piece of content.
